(19) United States
(12) Patent Application Publication
(10) Pub. No.: US 2006/0074583 A1
(43) Pub. Date: Apr. 6, 2006

(54) Methods and systems for unattended tracking of device transfer rates and reporting of performance degradation

(76) Inventors: Michael Bieker, Colorado Springs, CO (US); Scott Dominguez, Colorado Springs, CO (US); Joseph Maloy, Colorado Springs, CO (US); Brett Henning, Colorado Springs, CO (US)

Correspondence Address: Senior Corporate Counsel;LSI Logic Corporation, Legal Department - IP, 1621 Barber Lane, MS D-106, Milpitas, CA, 95035, US

(21) Appl. No.: 10/955,456

(22) Filed: Sep. 30, 2004

(51) Int. Cl. G06F 19/00

(52) U.S. Cl. 702/117

(57) ABSTRACT

An operating system's input/output control (IOCTL) interface can communicate with one or more device drivers, which may be implemented as Message Passing Technology (MPT) based drivers. At start-up and at user-defined intervals, Message Passing Interface (MPI) pass-through messages can be sent utilizing the IOCTL interface. Such messages can be formatted as Configuration Page Request messages, and can then return data that includes the current negotiated rates and widths for all devices connected via the bus. Whenever a drop in rate occurs for any device connected to the bus, the event will be logged, and the user informed. Utilizing such technology, device transfer rates can be automatically tracked performance degradation thereof reported.

### TECHNICAL FIELD

Embodiments are generally related to data-processing methods and systems. Embodiments are additionally related to message passing technology (MPT) and device drivers. Embodiments are particularly directed to methods and systems for testing bus and device transfer rates and providing performance information for such components.

### BACKGROUND OF THE INVENTION

In a conventional data-processing system, such as a computer and/or a computer network, one or more processors may communicate with input/output (I/O) devices over one or more buses. The I/O devices may be coupled to the processors through an I/O interface such as an I/O bridge, which can manage the transfer of information between a peripheral bus connected to the I/O devices and a shared bus connected to the processors. Additionally, the I/O interface may manage the transfer of information between system memory and the I/O devices or the system memory and the processors.

An I/O interface can also be utilized to transfer information between I/O devices and main storage components of a host processor. An I/O channel, for example, may connect the host directly to a mass storage device (e.g., disk or tape drive). In the case of a mainframe host processor, the channel is usually coupled to one or more device controllers. Each device controller can in turn be connected to a plurality of mass storage devices.

One example of an I/O interface that is become widely utilized in the data processing and computer arts is the so-called “Fibre Channel.” In general, features of both channels and networks have been incorporated into a network standard known as “Fibre Channel,” which has been defined by American National Standards Institute (ANSI) specifications, such as X3.230 (1994). Fibre Channel systems attempt to combine the speed and reliability of channels with the flexibility and connectivity of networks.

In general, data in a Fibre Channel network can be transported in packets, which may be two kilobytes or smaller. These packets of data can be referred to as “frames.” “Sequences” include one or more frames. Frames in a sequence are generally assembled at the receiving device in a predetermined order before the sequence can be considered complete.

Fibre Channel is a campus-wide interconnection standard that is designed primarily to interconnect peripherals, mass storage systems such as redundant arrays of inexpensive disks (RAID), imaging and archiving systems, mainframes, engineering workstations, and other high-speed devices. Often seen as the successor to the Small Computer Serial Interface (SCSI) standard, Fibre Channel is a high-speed channel that typically uses fiber optics to interconnect computing devices in a relatively local environment, such as a laboratory or a campus. Thus, the Fibre Channel focuses more on providing bandwidth between devices than a completely flexible network. Fibre Channel is a switched technology.

The Fibre Channel interface dedicates circuits for transferring data while allowing other devices to access the channel when it is free. The Fibre Channel interface supports variable length transmissions; it can transmit large blocks of data without dividing the blocks into smaller packets. The speed of Fibre Channel is in the range of 133 Mbit/sec-1062 Mbit/sec. While multimode optical fiber is used most often, single mode optical fiber, coaxial cable, and shielded twisted pair wire are also occasionally used in practice. An example of a Fibre Channel method and system is disclosed in U.S. Pat. No. 6,721,320, which issued on Apr. 13, 2004 to Hoglund et al and is assigned to LSI Logic Corporation based in Milpitas, Calif. U.S. Pat. No. 6,721,320 is incorporated herein by reference.

Another well-known I/O interface is Serial Attached SCSI (SAS). SAS incorporates feature of Small Computer System Interface (SCSI), also known as “skuzzy”, which is a bus protocol that allows various internal and external devices to be connected to personal computers, workstations, servers, and/or other data-processing systems. SAS is a is a point-to-point architecture, distinct from parallel technologies in which devices are connected utilizing shared-access topologies, such as a Fibre Channel arbitrated loop of the SCSI bus. As such, a point-to-point architecture establishes a link directly from the controller to a disk drive or through an expander-switching matrix. In shared-access topologies, only two devices can communicate at once. As well, as throughput needs increase, the shared-access medium can become a bottleneck and slow down communication. Shared access topologies also are typically more complex and have arbitration schemes that are more time consuming than point-to-point architectures.

In conventional environments for developing computer systems, it is often necessary to rigorously test the numerous facets of such systems, such as software modules, hardware components, and other information before the systems are marketed and distributed. Such tests can include tests for verifying compatibility, functional and engineering verification tests, human factors tests for user friendliness, etc., tests related to softcopy system documentation and the like. Testing various bus and device transfer rates is also an important task that must be performed prior to completion of the manufacturing process.

In current device driver test environments, there does not currently exist a method or system for constantly monitoring bus and device transfer rates during testing. A need therefore exists for a method and system for ensuring that bus/device transfer rates never drop unexpectedly during the course of a test effort. Current testing of bus/device transfer rates is accomplished by analyzing the rates at a single point in time utilizing a bus analyzer. Such a methodology does not verify that the rates have never dropped unexpectedly during the course of testing. By testing bus/device rates at several points in time utilizing a bus analyzer, a tester may be able to verify that the rates have never dropped during the course of testing. Such a methodology is, however, very time consuming. In generally, all such conventional approaches are time consuming and require a great deal of user intervention, and cannot adequately verify that bus/device rates have not fallen during the course of testing.

### BRIEF SUMMARY

The following summary of the invention is provided to facilitate an understanding of some of the innovative features unique to the present invention and is not intended to be a full description. A full appreciation of the various aspects of the invention can be gained by taking the entire specification, claims, drawings and abstract as a whole.

It is therefore one aspect of the present invention to provide for improved data-processing methods and systems.

It is another aspect of the present invention to provide methods, systems and program products for the unattended tracking of device transfer rates and reporting of performance degradation.

The above and other aspects of the invention can be achieved as will now be briefly described. Methods, systems, and program products for testing data-processing components are disclosed herein. In general, a plurality of components connected to a bus within a data-processing system can communicate with one or more input/output interfaces in communication with the bus. Data indicative of the current negotiated device transfer rate and width for the plurality of components connected to the bus can be generated, in response to automatically communication with the plurality of components connected to the bus within the data-processing system utilizing the input/output interface. A change in the device transfer rates and widths, if the change is detected, in response to analyzing the data indicative of a current negotiated device transfer rate and width for the plurality of components connected to the bus can then be recorded, thereby permitting the unattended tracking of the device transfer rates and widths and the reporting of performance degradation thereof.

An operating system's IOCTL interface can therefore communicate with one or more device drivers, which may be implemented as Message Passing Technology (MPT) based drivers. Thus, at start-up and at user-defined intervals, Message Passing Interface (MPI) pass-through messages can be sent utilizing such an IOCTL interface. Such messages can be formatted as Configuration Page Request messages, and can then return data that includes the current negotiated rates and widths for all devices connected via the bus. Whenever a drop in rate occurs for any device connected to bus, the event will be logged, and the user informed.

### BRIEF DESCRIPTION OF THE DRAWINGS

The accompanying figures, in which like reference numerals refer to identical or functionally similar elements throughout the separate views and which are incorporated in and form part of the specification, further illustrate embodiments of the present invention.

FIG. 1 illustrates a block diagram of a system in which a preferred embodiment of the present invention can be implemented;

FIG. 2 illustrates a flow chart of operations depicting logical operation steps that can be implemented in accordance with a preferred embodiment of the present invention; and

FIG. 3 illustrates a flow chart of operations depicting logical operation steps that can be implemented in accordance with an alternative embodiment of the present invention.

### DETAILED DESCRIPTION OF THE INVENTION

The particular values and configurations discussed in these non-limiting examples can be varied and are cited merely to illustrate embodiments of the present invention and are not intended to limit the scope of the invention.

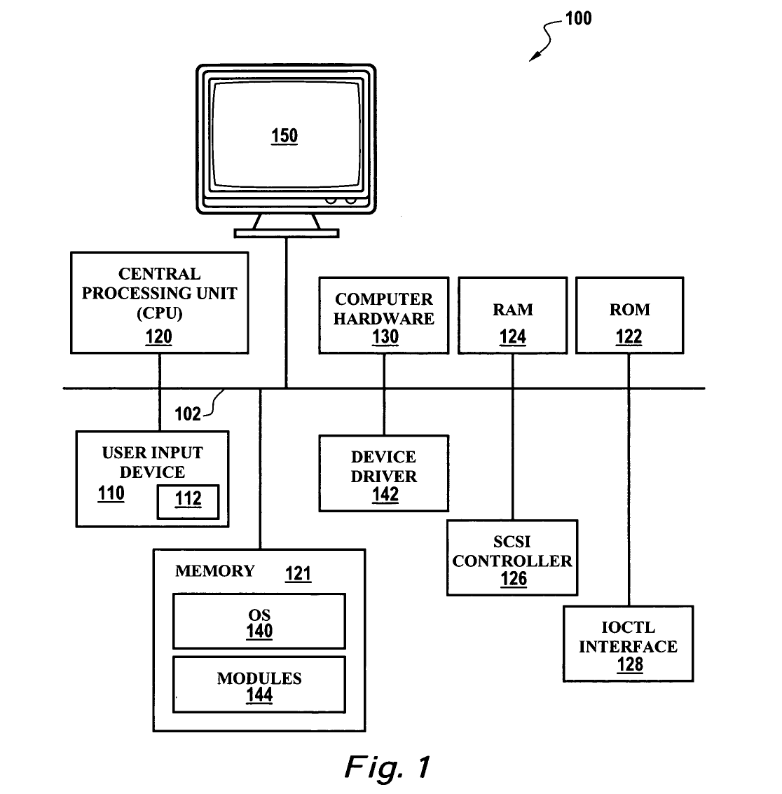

For a further understanding of the present invention, reference is made to FIG. 1, which depicts a data-processing system 100 in which an embodiment of the present invention can be implemented. Data processing system 100 of FIG. 1 generally includes a user input device 110, a central processing unit 120, computer hardware 130, and a monitor 150. The user input device 110 can be coupled to the central processing unit 120 wherein the central processing unit 120 is coupled to the computer hardware 130 and the operating system 140. User input device 110 can be implemented, for example, as a computer keyboard, a computer mouse, and so forth.

The central processing unit 120 is connected to a bus 102, which in turn can be connected to other system components, such as memory 121, Random Access Memory (RAM) 124, Read Only Memory (ROM) 124, a Small Computer Systems Interface (SCSI) controller 126, and an input/output control (IOCTL) interface 128. System bus 102 can also be connected to monitor 150, device driver 142 and user input device 110. The IOCTL interface 128 is generally associated with operating system 140. Note that device driver 142 can be implemented as an SCSI device driver, depending upon design considerations. Memory 121, which is coupled to bus 102, can communicate with the central processing unit 120 via bus 102. Operating system (OS) 140 can be stored as a module or series of software modules within memory 121 and processed via CPU 120. Note the term “module” is defied in greater detail herein.

Note that device driver 142 can be implemented as a software or instruction module stored in a memory, such as memory 121, which can be utilized to communicate with the SCSI controller 126. Thus, although device driver 142 is illustrated in FIG. 1 as a separate “block,” it can be appreciated that device driver 142 can be implemented in the context of a module storable in a computer memory. Device driver 126 generally functions as a module or group of modules that communicates between OS 140 and the controllers described herein. Similarly, IOCTL interface 128, which is also depicted in FIG. 1 as constituting a separate “block”, can form a part of OS 140 to allow for direct communication such as sending messages to and from device driver 126.

The operating system 140 is the master control program that runs the computer. It sets the standards for all application programs that run in the computer. Operating system 140 can be implemented as the software that controls the allocation and usage of hardware resources, such as memory 121, central processing unit 120, disk space, and other peripheral devices, such as monitor 150, user input device 110 and computer hardware 130. Examples of operating systems, which may be utilized to implement operating system 140 of system 100, include Windows, Mac, OS, UNIX and Linux.

Bus 102 can be implemented as a plurality of conducting hardware lines for data transfer among the various system components to which bus 102 is attached. Bus 102 functions as a shared resource that connects varying portions of data-processing system 100, including the CPY 120 (i.e., a microprocessor), controllers, memory and input/output ports and so forth and enabling the transfer of information. Bus 102 can be configured into particular bus components for carrying particular types of information. For example, bus 102 can be implemented to include a group of conducting hardware lines for carrying memory addresses or memory locations where data items can be found, while another group of conducting hardware lines can be dedicated to carrying control signals, and the like.

The user input device 110 can includes a plurality of device descriptor files 112. The device descriptor files 112 contain information related to the user input device, e.g. what type of device it is, who made the device, etc. The device descriptor files 112 can also contain user-defined fields called report descriptors. Report descriptors are strings of information that the operating system 140 can read. Report descriptors can be implemented, for example, as for passing useful information about the user input device 1110 to the operating system 140 and/or a device driver 142. Such report descriptors are unique for each type of user input device.

Note that embodiments of the present invention can be implemented in the context of modules. Such modules may constitute hardware modules, such as, for example, electronic components of a computer system. Such modules may also constitute software modules. In the computer programming arts, a software module can be typically implemented as a collection of routines and data structures that performs particular tasks or implements a particular abstract data type.

Software modules generally are composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. The term module, as utilized herein can therefore refer to software modules or implementations thereof. Such modules can be utilized separately or together to form a program product that can be implemented through signal-bearing media, including transmission media and recordable media.

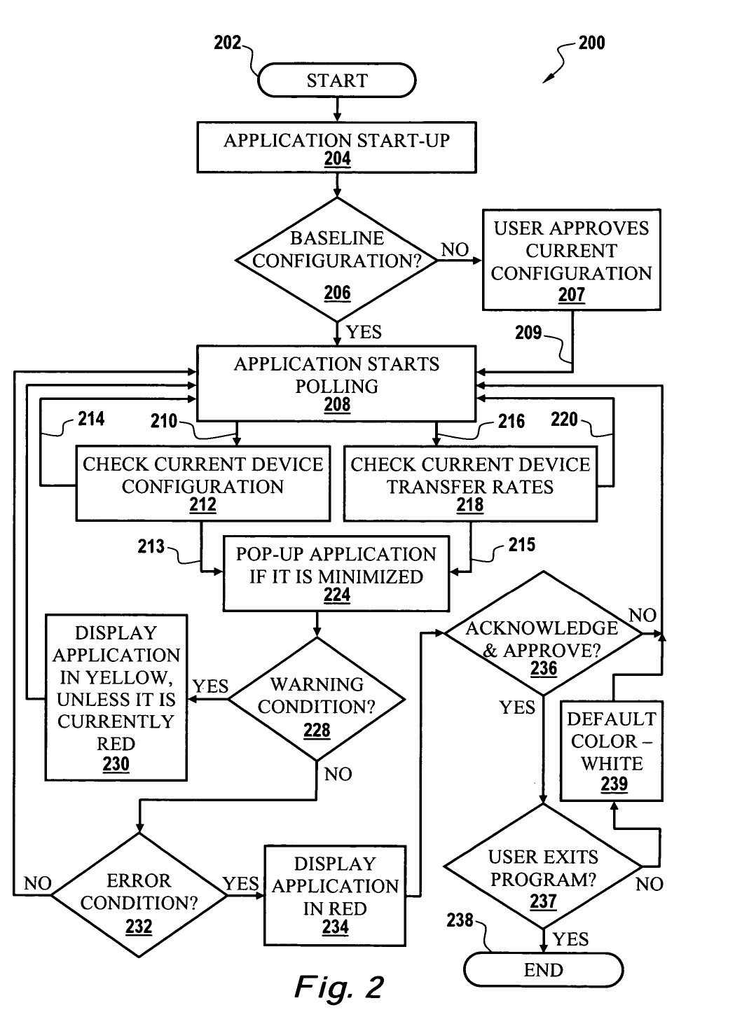

The methodology depicted in FIG. 2 can be implemented as one or more such modules. Such modules can be referred to also as “instruction modules” and may be stored within a memory of a data-processing system such as memory 121 of FIG. 1. Modules 144 depicted in FIG. 1 represent such instruction modules. Such instruction modules may be implemented in the context of a resulting program product.

FIG. 2 illustrates a flow chart 200 of operations depicting logical operation steps that can be implemented in accordance with a preferred embodiment of the present invention. As indicated at block 202, the process can be initiated. Then, as depicted at block 204, an application can start-up for the unattended tracking of device transfer rates and reporting of performance degradation. As described thereafter at block 206, a test can be performed to determine if a baseline configuration has been approved. If the baseline configuration has not been approved, then the operation depicted at block 207 is processed in which the user approves the current configuration.

Following processing of the operation depicted at block 207, arrow 209 indicates that the device rates have been approved and the baseline configuration saved. If the base line configuration has been approved as depicted at block 206, then the operation depicted at block 208 can be processed, in which the application actually begins polling. If the configuration-polling period has expired, which is represented by arrow 210, the operation illustrated at block 212 can be processed.

The operation depicted at block 212 involves checking the current device configuration against the saved baseline configuration. Note that during processing of the operation indicated at block 212, MPI messages can be sent to a controller to determine which devices are currently connected. This can be accomplished utilizing the operating system's IOCTL interface. Arrow 214, which occurs after processing of the operation depicted at block 212, indicates that no differences have been found. Thus, configuration polling starts anew as indicated at block 208. Arrow 213 indicates that differences have been found, so the operation depicted at block 224 is initiated.

Arrow 216, which occurs after block 208 and prior to block 218, indicates that the rate change polling period has expired. If the rate change polling period expires, then the operation described at block 218 is processed, in which current device transfer rates are checked against saved baseline device rates. Note that during the processing of the operation indicated at block 218, MPI messages can be sent to a controller to determine the transfer rates of all devices currently connected. This can be accomplished utilizing the operating system's IOCTL interface. Arrow 220, which occurs following block 218, indicates that no differences have been found, so that rate change polling starts anew in block 208. Arrow 215 indicates that a device rate change has been detected, so block 224 is entered.

When block 224 is entered, this means that either a device configuration change has been detected or a device rate change has been detected. Note that the application can be implemented in the form of a graphical user interface, which is displayable via display 150 shown in FIG. 1. During the processing of block 224, the application can “pop-up” to display in a display area of display 150 shown in FIG. 1, if it is currently minimized. This insures that the user will be aware that a change has occurred. The application can be displayed on display 150 of FIG. 1 in yellow if a warning condition is encountered, but will only be displayed in yellow if the application is not currently red from a previous error, as indicated by blocks 228 and 230. If an error condition is encountered, however, then the application is displayed on display 150 of FIG. 1 in red, as indicated at blocks 232 and 234. If an error condition is not encountered, then the process simply resumes polling in block 208. Note that if the result of the test depicted at block 232 is “NO ERROR”, the polling operation depicted at block 208 is processed again. Otherwise, the application is displayed in red as indicated at block 234.

Note that as utilized herein the term “pop-up” generally refers to the process and/or display of a so-called “pop-up” graphical application such as, for example, a pop-up window. A pop-up window, for example, is a graphically displayed device utilized in a graphical user interface application that appears in response to a particular action or a particular user action, such as when an option is selected. The pop-up window remains visible, for example, until a “mouse” button is activated or released. Another example of a “pop-up” is a pop-up menu, which in a graphical user interface is a menu that appears on-screen via display 150 of FIG. 1 when a user selects a certain item. Pop-up menus can appear anywhere on a display screen and generally vanish when a particular action takes place. In general, a “pop-up” can be implemented as graphical user interface display area, usually a small window, that suddenly appears (i.e., “pops up”) in the foreground of the graphical visual interface.

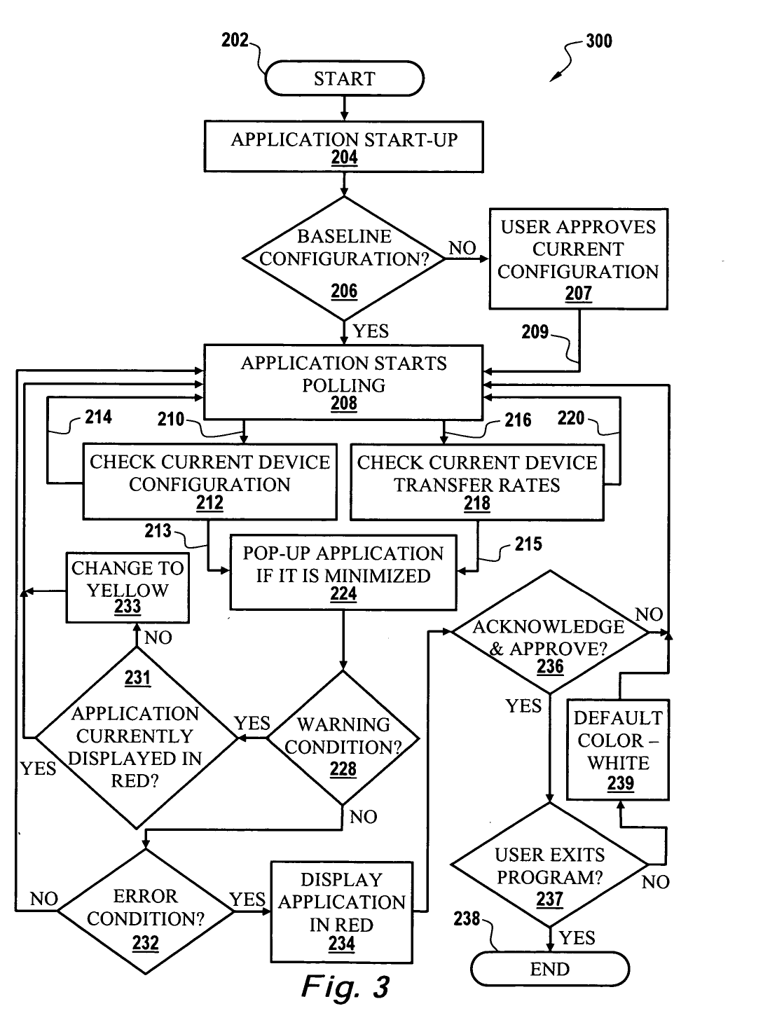

Following processing of the operation indicated at block 230, in which the application is displayed in yellow, the operation illustrated at block 208 is repeated. Following processing of the operation indicated at block 234, a test can be performed, as indicated at block 236, to determine if the user has acknowledged and approved the new configuration and/or rates. If so, then a test can be performed as indicated at block 237 to determine if the user desires to end the program. If it is determined to end the program, then the process simply terminates as depicted at block 238. If, however, it is determined not to terminate the application, then the process continues and changes the application background to the default white as indicated at block 239. Thereafter, the polling operation resumes as indicated at block 208. In general, the methodology or program depicted in FIGS. 2-3 ends only if the user manually exits. Otherwise, the process continues.

It can be appreciated that although block 238 is depicted in FIGS. 2-3 as occurring in response to decision block 237, block 238 may be located elsewhere in the flow process and is depicted in FIGS. 2-3 merely to illustrate one possible option for exiting the program. It is expected that alternative embodiments may provide the exit option to a user as depicted at blocks 237 and 238 at other locations within the flow process. Thus, the location of blocks 237 and 238 following block 236 and prior to block 239 is not considered a limiting feature of the invention.

Assuming that that the user has not acknowledged and approved the new configuration and/or rates as indicated at block 236, then the operation depicted at block 208 can be repeated, while maintaining the application displayed in red. In this manner, additional rate or configuration changes may be detected even as the application continues to show that at least one unapproved change has occurred. Such a methodology therefore enables the application to continue executing unattended.

The methodology depicted in FIGS. 2-3 herein generally utilizes the operating system's IOCTL interface 128 depicted in FIG. 1 to communicate with one or more device drivers, such as device driver 142 of FIG. 1. Note that device driver 142 can be implemented as a Message Passing Technology (MPT) based driver. Thus, at start-up and at user-defined intervals, Message Passing Interface (MPI) pass-through messages can be sent utilizing IOCTL interface 128. Such messages can be formatted as Configuration Page Request messages, and can then return data that includes the current negotiated rates and widths for all devices connected via SCSI Controller 126 or via another MPT based controller, such as a Fibre Channel and/or SAS Controller. Whenever a drop in rate occurs for any device connected to SCSI Controller 126, the event will be logged, and the user informed.

FIG. 3 illustrates a flow chart 300 of operations depicting logical operation steps that can be implemented in accordance with an alternative embodiment of the present invention. Note that flow chart 300 is similar to flow chart 200, except that flow chart 200 contains minor changes. In FIGS. 2-3, similar or identical parts are generally indicated by identical reference numerals. Thus, as indicated in flow chart 300, a test can be performed as depicted at block 231, which follows processing of the operation illustrated at block 228. Such a test is processed in order to determine if the application is currently displayed in red, indicating an error condition. If the application is currently displayed in red, the polling operation depicted at block 208 can then be processed. If the application is not displayed in red, the application color is changed to yellow as indicated at block 233, and the polling operation depicted at block 208 is then processed. Such a methodology can be implemented to make certain that the application displayed in error state is not overridden by a warning state.

Based on the foregoing, it can be appreciated that the embodiments disclosed herein can uniquely leverage MPT technology to provide continuous bus/device rate monitoring and tracking, while allowing for the unattended tracking and logging of bus/device rate change events and configuration change events. Such embodiments can be implemented in multiple operating systems due to the utilization of MPT technology in existing device drivers, such as, for example, device driver 142 depicted in FIG. 1. Such embodiments can also be implemented for any input/output (I/O) protocol supported through such an MPT interface, such as, for example, SCSI controller 126, Fibre Channel, and/or SAS.

The embodiments disclose herein offer a number of advantages, such as, the ability to act as a basic, low-cost bus speed analyzer, along with the ability to allow unattended tracking and logging of rate change and configuration change events in order to save time and money. Such embodiments also can be utilized under multiple operating systems to allow testing of a wider range of software using this method. Such embodiments can be implemented for any MPT supported I/O protocol, thereby also allowing for the testing of a wider range of software.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

1. A method for testing data-processing components, said method comprising the steps of:
automatically communicating with a plurality of components connected to a bus within a data-processing system utilizing at least one least input/output interface in communication with said bus during testing of said data-processing system;
generating data indicative of a current negotiated device transfer rate and width for said plurality of components connected to said bus, in response to automatically communication with said plurality of components connected to a bus within a data-processing system utilizing at least one least input/output interface in communication with said bus; and
recording a change in said device transfer rates and widths, if said change is detected, in response to analyzing said data indicative of a current negotiated device transfer rate and width for said plurality of components connected to said bus, thereby permitting the unattended tracking of said device transfer rates and widths and the reporting of performance degradation thereof.

2. The method of claim 1 wherein said at least one input/output interface comprises an IOCTL interface.

3. The method of claim 1 wherein the step of recording a change in said device transfer rates and widths, if said change is detected, further comprises the step of:
recording a drop in said device transfer rates and widths, if a drop in said device transfer rates and widths is detected, in response to analyzing said data indicative of a current negotiated device transfer rate and width for said plurality of components connected to said bus.

4. The method of claim 1 wherein the step of automatically communicating with a plurality of components connected to a bus within a data-processing system utilizing at least one least input/output interface in communication with said bus, further comprises the step of:
at user-defined intervals, transmitting pass-through messages from said at least one input/output interface to said plurality of components connected to said bus.

5. The method of claim 1 wherein the step of automatically communicating with a plurality of components connected to a bus within a data-processing system utilizing at least one least input/output interface in communication with said bus, further comprises the step of:
at a start-up of said data-processing system, transmitting pass-through messages from said at least one input/output interface to said plurality of components connected to said bus.

6. The method of claim 1 further comprising the step of configuring said plurality of components to comprise a memory, a device driver, a processor, and a controller connected to said bus.

7. The method of claim 1 wherein an operating system module is stored within said memory for processing via said processor.

8. A system for testing data-processing components, said system comprising:
a plurality of components connected to a bus within a data-processing system utilizing at least one least input/output interface in communication with said bus;
at least one input/output interface for generating data indicative of a current negotiated device transfer rate and width for said plurality of components connected to said bus, wherein said data is generated in response to automatically communicating with said plurality of components connected to said bus within said data-processing system utilizing said least one least input/output interface; and
wherein a change in said device transfer rates and widths is recordable, if said change is detected, in response to analyzing said data indicative of a current negotiated device transfer rate and width for said plurality of components connected to said bus, thereby permitting the unattended tracking of said device transfer rates and widths and the reporting of performance degradation thereof.

9. The system of claim 8 wherein said at least one input/output interface comprises an IOCTL interface.

10. The system, of claim 8 wherein a drop in said device transfer rates and widths is recordable, if said drop in said device transfer rates and widths is detected, in response to analyzing said data indicative of a current negotiated device transfer rate and width for said plurality of components connected to said bus.

11. The system of claim 8 wherein at user defined intervals, pass-through messages are transmitted from said at least one input/output interface to said plurality of components connected to said bus.

12. The system of claim 8 wherein at a start-up of said data-processing system, pass-through messages are transmitted from said at least one input/output interface to said plurality of components connected to said bus.

13. The system of claim 8 wherein said plurality of components comprises a memory, a device driver, a processor, and a controller connected to said bus.

14. The system of claim 13 further comprising an operating system module stored within said memory for processing via said processor.

15. A program product for testing data-processing components, said program product comprising the steps of:
instruction module residing in a memory of a data-processing system for automatically communicating with a plurality of components connected to a bus within a data-processing system utilizing at least one least input/output interface in communication with said bus during testing of said data-processing system;
instruction module residing in a memory of a data-processing system for generating data indicative of a current negotiated device transfer rate and width for said plurality of components connected to said bus, in response to automatically communication with said plurality of components connected to a bus within a data-processing system utilizing at least one least input/output interface in communication with said bus; and
instruction module residing in a memory of a data-processing system for recording a change in said device transfer rates and widths, if said change is detected, in response to analyzing said data indicative of a current negotiated device transfer rate and width for said plurality of components connected to said bus, thereby permitting the unattended tracking of said device transfer rates and widths and the reporting of performance degradation thereof.

16. The program product of claim 15 wherein said at least one input/output interface comprises an IOCTL interface.

17. The program product of claim 15 wherein said instruction module residing in a memory of a data-processing system for recording a change in said device transfer rates and widths, if said change is detected, further comprises:
instruction module residing in a memory of a data-processing system for recording a drop in said device transfer rates and widths, if a drop in said device transfer rates and widths is detected, in response to analyzing said data indicative of a current negotiated device transfer rate and width for said plurality of components connected to said bus.

18. The program product of claim 15 wherein said instruction module residing in a memory of a data-processing system for automatically communicating with a plurality of components connected to a bus within a data-processing system utilizing at least one least input/output interface in communication with said bus, further comprises:
instruction module residing in a memory of a data-processing system for at user defined intervals, transmitting pass-through messages from said at least one input/output interface to said plurality of components connected to said bus.

19. The program product of claim 15 wherein said instruction module residing in a memory of a data-processing system for automatically communicating with a plurality of components connected to a bus within a data-processing system utilizing at least one least input/output interface in communication with said bus, further comprises:
instruction module residing in a memory of a data-processing system for at a start-up of said data-processing system, transmitting pass-through messages from said at least one input/output interface to said plurality of components connected to said bus.

20. The program product of claim 15 wherein said plurality of components comprise a memory, a device driver, a processor, and a controller connected to said bus, and wherein an operating system module is stored within said memory for processing via said processor.
